(19) United States
(12) Patent Application Publication
(10) Pub. No.: US 2023/0101453 A1
(43) Pub. Date: Mar. 30, 2023

(54) METHOD AND WIRELESS NETWORK FOR MANAGING AERIAL SUBSCRIPTIONS INFORMATION OF UAV

(71) Applicant: Samsung Electronics Co., Ltd., Gyeonggi-do (KR)

(72) Inventors: Ashok Kumar NAYAK, Bangalore (IN); Dongyeon KIM, Gyeonggi-do (KR)

(21) Appl. No.: 17/951,755

(22) Filed: Sep. 23, 2022

(30) Foreign Application Priority Data
Sep. 23, 2021 (IN) 202141043105
Aug. 26, 2022 (IN) 202141043105

(51) Int. Cl. H04W 60/04; H04W 8/20

(52) U.S. Cl. CPC H04W 60/04; H04W 8/20

(57) ABSTRACT

Disclosed is a method related to a 5G or 6G communication system for supporting a higher data transmission rate. The method is for updating aerial subscription information to a UAV in a wireless network by an AMF device, including receiving a first registration request message comprising a CAA-level UAV identifier from the UAV for accessing a UAS service; determining whether an aerial subscription for the UAS service is allowed for the UAV by a UDM device; sending a registration reject message with an indication that the UAS service is not available to the UAV in response to determining that the aerial subscription for the UAS service is not allowed for the UAV; and registering the UAV for a standard service.

### CROSS REFERENCE TO RELATED APPLICATION(S

This application is based on and claims priority under 35 U.S.C. §119 to Indian Provisional Patent Application No. 202141043105 and Indian Complete Patent Application No. 202141043105, which were filed on Sep. 23, 2021 and Aug. 26, 2022, respectively, the entire disclosure of each which is incorporated herein by reference.

### BACKGROUND

### 1 Field

The disclosure relates generally to supporting uncrewed aerial systems (UAS) connectivity, identification, and tracking in a 3^{rd} generation partnership project (3GPP), and more particularly, to a wireless network and a method of ensuring that a fifth generation (5G) system is able to update aerial subscription information to a user equipment (UE)/uncrewed aerial vehicle (UAV).

### 2 Description of Related Art

5G mobile communication technologies define broad frequency bands such that high transmission rates and new services are possible, and can be implemented not only in sub 6 GHz bands such as 3.5 GHz, but also in above 6 GHz bands referred to as mmWave including 28 GHz and 39 GHz. In addition, it has been considered to implement 6^{th} generation (6G) mobile communication technologies (referred to as beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) (code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by future 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN), which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended reality (XR) for efficiently supporting augmented reality) (AR), virtual reality (VR), (mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Accordingly, the disclosure has been made to address at least the above-mentioned problems and/or disadvantages and to provide at least the advantages described below. The disclosed embodiments provide an apparatus and method for effectively providing a service in a mobile communication system.

In accordance with an aspect of the disclosure, a method is provided for managing or updating aerial subscription information of a UAV in a wireless network. The method includes receiving, by an access and mobility management function (AMF) device in the wireless network, a first registration request message including a civil aviation administration (CAA)-level UAV identifier from the UAV for accessing a UAS service; determining, by the AMF device, whether an aerial subscription for the UAS service is allowed for the UAV in the wireless network; sending, by the AMF device, a registration reject message with an indication indicating that the UAS service is not available to the UAV in response to determining that the aerial subscription for the UAS service is not allowed for the UAV; receiving, by the AMF device 200, the second registration request message regarding a standard service (or, normal service)from the UAV 100 and registering, by the AMF device, the UAV for a standard service (or, normal service) (e.g., UAV wanted to download or update a server, update some configuration or the like) in response to determining that the aerial subscription for the UAS service is not allowed for the UAV.

In accordance with a further aspect of the disclosure, a method is provided for updating or managing aerial subscription information of an UAV in a wireless network, including sending, by the UAV, a first registration request message including a CAA-level UAV identifier to an AMF device in the wireless network for accessing an UAS service; receiving, by the UAV, a registration reject message with an indication that the UAS service is not available from the AMF device when an aerial subscription for the UAS service is not allowed for the UAV by a UDM device in the wireless network; sending by the UAV, a second registration request message for a standard service (or, normal service) in response to determining that the aerial subscription for the UAS service is not allowed for the UAV; receiving, by the UAV, a registration accept message for the standard service (or, normal service) from the AMF device; receiving, by the UAV, the aerial subscription information from the AMF device when the aerial subscription for the UAS service is allowed for the UAV by the UDM device for a predetermined period of time; sending, by the UAV, a third registration request message with the CAA-level UAV identifier to the AMF device for the UAS service based on the aerial subscription information; and receiving, by the UAV, a registration accept message for the UAS service from the AMF device.

In accordance with another aspect of the disclosure, a wireless network is provided for managing or updating aerial subscription information of an UAV in the wireless network, the wireless network including a UDM device and an AMF device communicating with a UDM device, with the AMF device including a Memory, a processor and an aerial subscription information controller communicatively coupled to the memory and the processor. The aerial subscription information controller is configured to receive a registration request message with a CAA-level UAV identifier from the UAV for an UAS service; determine whether an aerial subscription for the UAS service is allowed for the UAV by the UDM device in the wireless network; send a registration reject message with an indication that the UAS service is not available to the UAV in response to determining that the aerial subscription for the UAS service is not allowed for the UAV; receive a second registration request message for a standard service (or, normal service) from the UAV; and register the UAV for the standard service (or, normal service) after receiving the second registration request message.

In accordance with a further aspect of the disclosure, a UAV is provided for managing or updating aerial subscription information in a wireless network, with the UAV including a memory, a processor and an aerial subscription information controller communicatively coupled to the memory and the processor. The aerial subscription information controller is configure to send a registration request message with a CAA-level UAV identifier to an AMF device in the wireless network for a UAS service; receive a registration reject message with an indication that the UAS service is not available from the AMF device when an aerial subscription for the UAS service is not allowed for the UAV by a UDM device in the wireless network; send a registration request message for a standard service (or, normal service) in response to determining that the aerial subscription for the UAS service is not allowed for the UAV; receive a registration accept message for the standard service (or, normal service) from the AMF device; receive the aerial subscription information from the AMF device, when the aerial subscription for the UAS service is allowed for the UAV by the UDM device; send a third registration request message with the CAA-level UAV identifier to the AMF device for the UAS service based on the aerial subscription information; and receive a registration accept message for the UAS service from the AMF device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a UE specific search space (USS) UAV authorization/authentication (UUAA) in a context of a registration procedure (UUAA-MM), according to an embodiment;

FIG. 2 illustrates an AMF updating the aerial subscription information to a UE/UAV, according to an embodiment;

FIG. 3 illustrates various hardware components of the UE/UAV, according to an embodiment;

FIG. 4 illustrates various hardware components of an AMF device, according to an embodiment;

FIG. 5 is a flow chart illustrating a method, implemented by the UE/UAV, to re-attempt registration by sending mobility registration or periodic registration update after being notified by the AMF about aerial subscription information to the UE/UAV in a wireless network, according to an embodiment;

FIG. 6 is a flow chart illustrating a method, implemented by the AMF device, for updating aerial subscription information to the UE/UAV in the wireless network, according to an embodiment.

FIG. 7 illustrates a structure of a UE/UAV according to an embodiment;

FIG. 8 illustrates a structure of a base station according to an embodiment; and

FIG. 9 is a block diagram illustrating an internal structure of a network entity, according to an embodiment.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The terms “UE” and “UAV” are used interchangeably in the patent disclosure.

Below are the abbreviations used in the patent description:
1) UAS - Uncrewed Aerial System
2) UAV - Uncrewed Aerial Vehicle
3) UUAA - USS UAV Authorization/Authentication
4) AMF - Access and Mobility Management Function
5) UDM - Unified Data Management
6) UE - User Equipment

Accordingly, a method is provided for updating aerial subscription information to an UAV in a wireless network. The method includes receiving, by an AMF device in the wireless network, a first registration request message including a CAA-level UAV identifier from the UAV for accessing an UAS service. The terms UE and UAV are used interchangeably herein. The method also includes determining, by the AMF device, whether an aerial subscription for the UAS service is allowed for the UAV by a UDM device in the wireless network. Further, the method includes sending, by the AMF device, a registration reject message with an indication indicating that the UAS service is not available to the UAV in response to determining that the aerial subscription for the UAS service is not allowed for the UAV. Further still, the method includes registering, by the AMF device, the UAV for a standard service (or, normal service). Standard service (or, normal service) includes a UAV request to download or update a server, configuration update, and similar conventional service request.

The method can be used to update the UE/UAV about the information that aerial subscription has been allowed using a UCU procedure or a UPU procedure so that the UE/UAV can re-initiate registration procedure with CAA-Level UAV ID to obtain the aerial service.

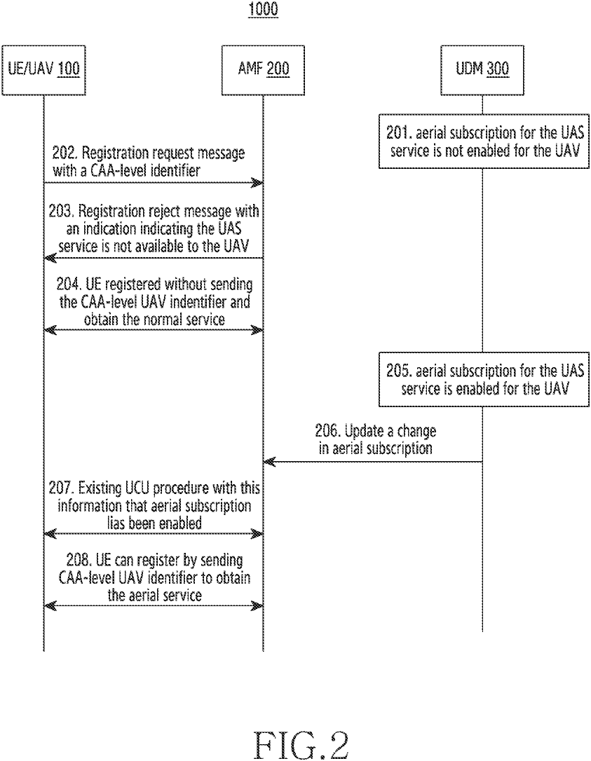

Referring now to the drawings and more particularly to FIGS. 2 through 6, where similar reference characters denote corresponding features consistently throughout the figures, there are shown preferred embodiments.

3GPP TS 23.256 defines the architecture enhancements for supporting UAS connectivity, identification, and tracking, and specifies functions that include:
1) UAV identification, authentication and authorization including re-authentication and re-authorization, and
2) UAV tracking in the 3GPP system, including how the 3GPP system can provide support for UAV to ground identification (e.g. to authorized third parties such as police devices).

Regarding handling of unauthorized UAVs and revocation of authorization, a UUAA procedure is executed either at registration (UUAA-MM) or during an ongoing active protocol data unit (PDU) session establishment / protocol data network (PDN) connection (UUAA-SM) for authentication and authorization of the UAV before providing any aerial service.

Embodiments described herein provide a method and a wireless network for managing or updating aerial subscription information of an UAV in the wireless network.

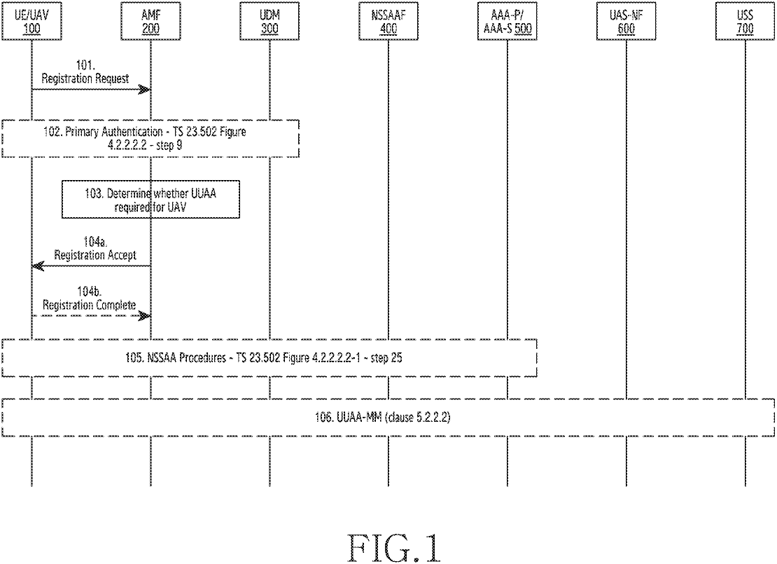

FIG. 1 illustrates a UUAA in the context of the registration procedure (UUAA-MM), according to an embodiment.

A registration request is received in step 101 of FIG. 1. In step 102, the UDM 300 performs a primary authentication. In step 103, a determination is made whether a UUAA is required for the UE/UAV. Further to conventional methods, in the steps 104a and 104b, if the UUAA is configured in the AMF device 200 to be performed during 5GS registration and the UE/UAV 100 has provided a CAA-Level UAV ID in the registration request of step 101 but the UE does not have an aerial subscription in the UE subscription data retrieved from the UDM 300 in step 102, then the UDM 300 rejects the registration with an indication that UAS services are not allowed, thus triggering the UE/UAV 100 to deny re-registration for aerial services and ensuring that the UE/UAV 100 is not allowed to access any aerial service.

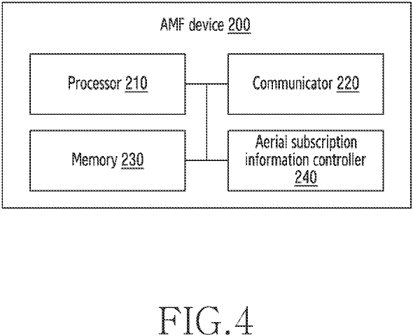

In step 105, the NSSAA Procedures are performed in accordance with Figure 4.2.2.2.2–1 - step 25 of TS 23.502.

In step 106, the UUAA-MM are performed in accordance with clause 5.2.2.2, with communications between a network slice specific authentication and authorization function (NSSAAF) (400), primary and secondary authentication, authorization and accounting functions (500), a UAS network function (UAS-NF) (600) and a USS (700).

After the UE registration is rejected, the UE/UAV 100 may perform a standard registration (or, normal registration) without sending CAA-Level UAV ID and will get standard services (or, normal services) from the network. At any point of time if operator allows the aerial subscription for the UE/UAV 100, then the UE/UAV 100 is not aware of this change. Without knowing this information from the network, the UE is not able to send the CAA-Level UAV ID to receive the aerial service.

As described above, the UE’s registration was rejected because its aerial subscription is not allowed. Then, the UE performs a standard registration (or, normal registration) without sending CAA-Level UAV ID. Thus, the UE receives only standard services (or, normal services) from the network. The UE is updated about the information that an aerial subscription has been allowed using a UCU procedure or a UPU procedure. Then, when the UE wants to get aerial service, the UE can send CAA-level UAV ID using mobility registration update or initial registration. FIG. 2 illustrates the AMF device 200 updating the aerial subscription information to UE/UAV 100, according to an embodiment. In step 201, the aerial subscription for the UAS service is not allowed for the UE/UAV 100 at the UDM 300. In step 202, the UE/UAV 100 sends the registration request message with the CAA-level UAV identifier to the AMF device 200. In step 203, the AMF device 200 sends the registration reject message with the indication indicating that the UAS service is not available to the UE/UAV 100. In step 204, the UE/UAV 100 is registered without sending the CAA-level UAV identifier and the standard service (or, normal service) (e.g., UAV wanted to download or update a server, update some configuration or the like) is obtained. In step 205, the aerial subscription for the UAS service is allowed for the UE/UAV 100 at the UDM 300. In step 206, the UDM (300) sends the update of the change in aerial subscription to the AMF device 200. In step 207, an existing UCU procedure is allowed by the AMF device 200 at the UE/UAV 100 with this information that the aerial subscription. In step 208, the UE/UAV 100 can register by sending CAA-level UAV identifier to obtain the aerial service.

The UDM 300 updates to the AMF device 200 after the operator enables the aerial subscription for UE/UAV 100. In an embodiment, it is proposed that the AMF device 200 updates the Aerial subscription information to the UE/UAV 100 so that the UE/UAV 100 can get aerial service by doing registration with CAA-level UAV ID.

Either the UCU or the UPU can be used to update the UE regarding the aerial subscription being allowed. The UE/UAV 100 can wait for any ongoing active PDU session to expire before sending CAA-level UAV ID in registration to get aerial service. The UE/UAV 100 can deregister (i.e., the UE 100 in a standard registration state (or, in a normal registration state) while obtaining aerial subscription information from the AMF) and then trigger initial registration with CAA-level UAV ID or the UE/UAV 100 can trigger mobility registration update with CAA-Level UAV ID to get standard service (or, normal service).

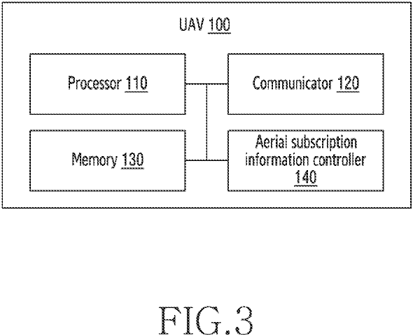

FIG. 3 illustrates various hardware components of the UE/UAV100, according to an embodiment. The UE/ UAV100 includes a processor110, a communicator120, a memory130 and an aerial subscription information controller140. The processor110 is coupled with the communicator120, the memory130 and the aerial subscription information controller140.

The aerial subscription information controller 140 sends (or transmits) the first registration request message including the CAA-level UAV identifier to the AMF device 200 for accessing the UAS service. Further, the aerial subscription information controller 140 receives the registration reject message with the indication indicating that the UAS service is not available from the AMF device 200 when the aerial subscription for the UAS service is not enabled for the UE/UAV 100 by the UDM 300. The aerial subscription information controller 140 then sends (or transmits) a second registration request message for the standard service (or, normal service) in response to determining that the aerial subscription for the UAS service is not allowed for the UE/UAV 100. Also, the aerial subscription information controller 140 receives the registration accept message for the standard service (or, normal service) from the AMF device 200. The aerial subscription information controller 140 the receives the aerial subscription information from the AMF device 200 when the aerial subscription for the UAS service is allowed for the UE/UAV 100 by the UDM 300. The aerial subscription information controller 140 receives the aerial subscription information from the AMF device 200 in one of a UCU procedure or a UPU procedure.

The aerial subscription information controller 140 sends (or transmits) the third registration request message with the CAA-level UAV identifier to the AMF device 200 for the UAS service based on the aerial subscription information. In an embodiment, the aerial subscription information controller 140 sends the mobility registration update message or the periodic registration update message with the CAA-level UAV identifier to the AMF device 200 to obtain the UAS service. In another embodiment, the aerial subscription information controller 140 detects the ongoing active PDU session associated with (or related with) the standard service (or, normal service) and determines whether the ongoing active PDU session is completed. Further, the aerial subscription information controller 140 sends a de-registration request message to the AMF device 200 and receives a de-registration accept message from the AMF device 200. The aerial subscription information controller 140 then sends the registration request message with the CAA-level UAV identifier to the AMF device 200 for the UAS service. The aerial subscription information controller 140 receives the registration accept message for the UAS service from the AMF device 200.The aerial subscription information controller 140 is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The operation of the aerial subscription information controller 140 may be performed by the processor 110. For example, the UE/UAV 100 may include the processor 110 and the communicator 120 and may not include the aerial subscription information controller 140, and the processor is configured to perform the operations of the aerial subscription information controller 140. That is, the aerial subscription information controller is replaced by the processor 110.

The processor 110 is configured to execute instructions stored in the memory130 and to perform various processes. The processor 110 may include a single processor or may include a plurality of processors. For example, the processor 110 may include a single computing processor. The processor 110 may also include a computing processor and communication processor. That is, the processor 110 may include one or more processors.

The communicator 120 is configured for communicating internally between internal hardware components and with external devices via one or more networks. The communicator 120 may include at least one of a transmitter or a receiver. That is, the communicator 120 may include at least one transceiver.

The memory 130 also stores instructions to be executed by the processor 110. The memory 130 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. In certain examples, a non-transitory storage medium may store data that can, over time, change (e.g., in random access memory (RAM) or cache).

FIG. 3 illustrates various hardware components of the UE/ UAV 100. However, other embodiments are not limited thereon. In other embodiments, the UE/UAV 100 may include fewer or a greater number of components. Further, the labels or names of the components are used only for illustrative purposes. One or more components can be combined together to perform same or substantially similar function in the UE/UAV 100.

FIG. 4 illustrates various hardware components of the AMF device (“AMF”) 200, according to an embodiment.

Referring to FIG. 4, the AMF device 200 includes a processor 210, a communicator 220, a memory 230 and an aerial subscription information controller 240. The processor 210 is coupled with the communicator 220, the memory 230 and the aerial subscription information controller 240.

The aerial subscription information controller 240 receives the registration request message includes the CAA-level UAV identifier from the UE/UAV 100 for the UAS service. In an embodiment, the aerial subscription information controller 240 receives a mobility registration update message or a periodic registration update message with the CAA-level UAV identifier from the UE/UAV 100 for the UAS service to obtain the UAS service without interrupting an existing registration for the standard service (or, normal service). In another embodiment, the aerial subscription information controller 240 receives a de-registration request message form the UE/UAV 100 for the standard service (or, normal service) and send a de-registration accept message to the UE/UAV 100. The aerial subscription information controller 240 receives the registration request message with the CAA-level UAV identifier from the UE/UAV 100 for the UAS service.

The aerial subscription information controller 240 determines (or identify) whether an aerial subscription for the UAS service is allowed for the UE/UAV 100 by the UDM 300. The aerial subscription information controller 240 sends (or transmits) a registration reject message with an indication indicating that the UAS service is not available to the UAV in response to determining that the aerial subscription for the UAS service is not allowed for the UAV. The aerial subscription information controller 240 registers the UE/UAV 100 for the standard service (or, normal service) in response to determining that the aerial subscription for the UAS service is not allowed for the UE/UAV 100.

The aerial subscription information controller 240 receives the aerial subscription information from the UDM 300 indicating that the aerial subscription for the UAS service is allowed for the UE/UAV 100. The aerial subscription information controller 240 sends (or transmits) the aerial subscription information to the UE/UAV 100 with the indication indicating that the UAS service is available to the UE/UAV 100. The aerial subscription information controller 240 sends the aerial subscription information to the UE/UAV 100 in one of a UCU procedure or a UPU procedure.

The aerial subscription information controller 240 receives a registration request message with the CAA-level UAV identifier from the UE/UAV 100 for the UAS service. Based on the aerial subscription information available at the AMF device 200, the aerial subscription information controller 240 registers the UE/UAV 100 for the UAS service. The aerial subscription information controller 240 sends the registration accept message to the UE/UAV 100 for the UAS service.

The aerial subscription information controller 240 is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Operation of the aerial subscription information controller 240 may be performed by the processor 210. For example, the AMF device 200 may include the processor 210 and the communicator 220 and may not include the aerial subscription information controller 140, and the processor 210 is configured to perform the operations of the aerial subscription information controller 240. That is, the aerial subscription information controller is replaced by the processor 210.

The processor 210 is configured to execute instructions stored in the memory 230 and to perform various processes. The processor 210 may include a single processor or may include a plurality of processors. For example, the processor 210 may include a single computing processor. The processor 210 may also include a computing processor and communication processor. That is, the processor 210 may include one or more processors.

The communicator 220 is configured for communicating internally between internal hardware components and with external devices via one or more networks. The communicator 220 may include at least one of a transmitter or a receiver. That is, the communicator 220 may include at least one transceiver.

The memory 230 also stores instructions to be executed by the processor 210. The memory 230 may include non-volatile storage elements. Examples of such non-volatile storage elements may include magnetic hard discs, optical discs, floppy discs, flash memories, or forms of EPROM or EEPROM memories. In addition, the memory 230 may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

FIG. 4 illustrates various hardware components of the AMF device 200, but is not so limited. In other embodiments, the AMF device 200 may include fewer or a greater number of components. Further, the labels or names of the components are used only for illustrative purposes. One or more components can be combined together to perform same or substantially similar function in the AMF device 200.

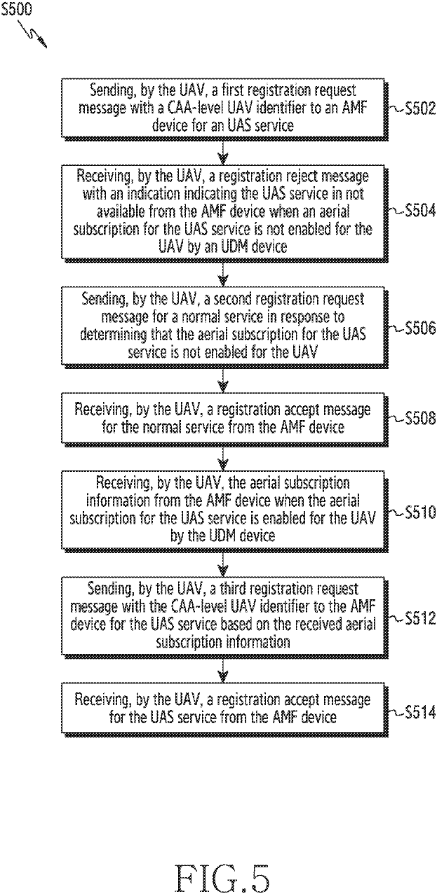

FIG. 5 is a flow chart (S500) illustrating a method, implemented by the UE/UAV 100, to re-attempt registration by sending mobility registration or periodic registration update after being notified by the AMF about aerial subscription information to the UE/UAV 100 in the wireless network 1000, according to an embodiment. Operations (S502-S514) are handled by the aerial subscription information controller 140.

Referring to FIG. 5, at operation S502, the first registration request message is sent (or transmitted) with the CAA-level UAV identifier to the AMF device 200 for accessing the UAS service. At operation S504, the registration reject message is received with the indication indicating that the UAS service is not available from the AMF device 200 when the aerial subscription for the UAS service is not allowed for the UAV by the UDM 300. At operation S506, the second registration request message is sent (or transmitted) for the standard service (or, normal service) in response to determining that the aerial subscription for the UAS service is not allowed for the UE/UAV 100.

At operation S508, the registration accept message is received for the standard service (or, normal service) from the AMF device 200. At operation S510, the aerial subscription information is received from the AMF device 200 when the aerial subscription for the UAS service is allowed for the UE/UAV 100 by the UDM (300). At operation S512, the third registration request message is sent (or transmitted) with the CAA-level UAV identifier to the AMF device 200 for the UAS service based on the received aerial subscription information. At operation S514, the registration accept message for the UAS service is received from the AMF device 200.

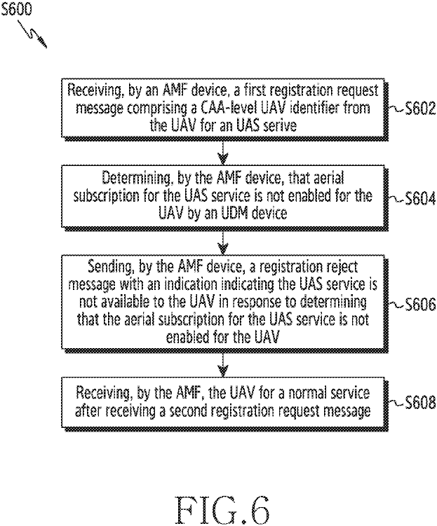

FIG. 6 is a flow chart (S600) illustrating a method, implemented by the AMF device 200, for updating aerial subscription information to the UE/UAV (100) in the wireless network (1000), according to an embodiment. Operations (S602-S608) are handled by the aerial subscription information controller 240.

Referring to FIG. 6, at operation S602, the registration request message including the CAA-level UAV identifier is received from the UE/UAV (100) for accessing the UAS service. At operation S604, the aerial subscription for the UAS service that is not allowed for the UE/UAV (100) is determined (identified) by the UDM (300) device. At operation S606, the registration reject message is sent (or transmitted) with the indication indicating that the UAS service is not available to the UE/UAV 100 in response to determining that the aerial subscription for the UAS service is not allowed for the UE/UAV 100. At operation S608, the UE/UAV 100 is registered for the standard service (or, normal service) after receiving a second registration message from the UE/UAV 100.

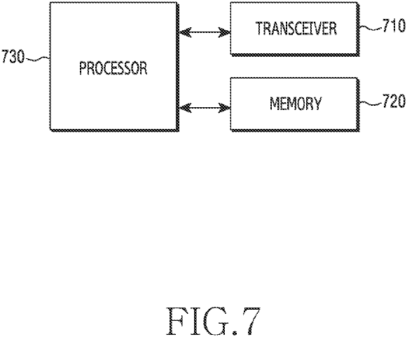

FIG. 7 illustrates a structure of a UE according to an embodiment. As shown in FIG. 7, the UE includes a transceiver 710, a memory 720, and a processor 730. The transceiver 710, the memory 720, and the processor 730 of the UE may operate according to a communication method of the UE described above. However, the components of the UE are not limited thereto. For example, the UE may include fewer or a greater number of components than those described above. In addition, the processor 730, the transceiver 710, and the memory 720 may be implemented as a single chip. Also, the processor 730 may include at least one processor. The UE of FIG. 7 corresponds to the UE/UAV 100 of the FIG. 3.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include an RF transmitter for up-converting and amplifying a frequency of a transmitted signal, and an RF receiver for amplifying low-noise and down-converting a frequency of a received signal. However, this is only an example of the transceiver 710 and components of the transceiver 710 are not limited to the RF transmitter and the RF receiver.

The transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as a read-only memory (ROM), a RAM, a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

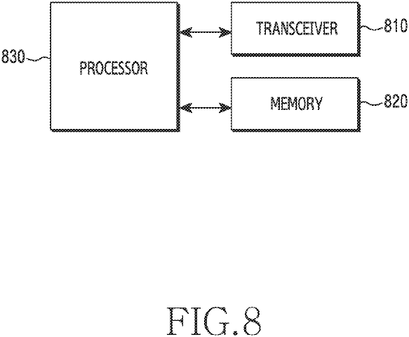

FIG. 8 illustrates a structure of a base station according to an embodiment. As shown in FIG. 8, the base station includes a transceiver 810, a memory 820, and a processor 830. The transceiver 810, the memory 820, and the processor 830 of the base station may operate according to a communication method of the base station described above. However, the components of the base station are not limited thereto. For example, the base station may include fewer or a greater number of components than those described above. In addition, the processor 830, the transceiver 810, and the memory 820 may be implemented as a single chip. Also, the processor 830 may include at least one processor. The base station of FIG. 8 may be managed by the AMF or the AMF device 200 of the FIG. 2. The base station ofFIG. 8 may support the communication of the UE/UAV 100 of FIG. 1.

The transceiver 810 collectively refers to a base station receiver and a base station transmitter, and may transmit/receive a signal to/from a terminal (or a UE) or a network entity. The signal transmitted or received to or from the terminal or a network entity may include control information and data. The transceiver 810 may include an RF transmitter for up-converting and amplifying a frequency of a transmitted signal, and an RF receiver for amplifying low-noise and down-converting a frequency of a received signal. However, this is only an example of the transceiver 810 and components of the transceiver 810 are not limited to the RF transmitter and the RF receiver.

The transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as a ROM, a RAM, a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

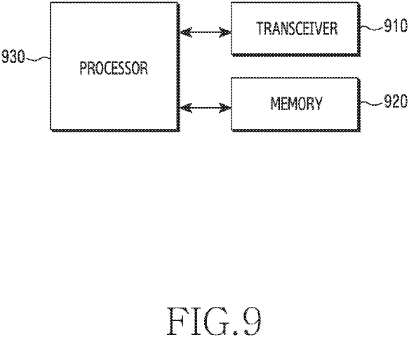

FIG. 9 is a block diagram showing an internal structure of a network entity, according to an embodiment.

As shown in FIG. 9, the network entity includes a transceiver 910, a memory 920, and a processor 930. The transceiver 910, the memory 920, and the processor 930 of the network entity may operate according to a communication method of the network entity described above. However, the components of the terminal are not limited thereto. For example, the network entity may include fewer or a greater number of components than those described above. In addition, the processor 930, the transceiver 910, and the memory 920 may be implemented as a single chip. Also, the processor 930 may include at least one processor. The network entity of FIG. 9 corresponds to the AMF device 200 of the FIG. 4.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver 910 collectively refers to a network entity receiver and a network entity transmitter, and may transmit/receive a signal to/from a base station or a UE. The signal transmitted or received to or from the base station or the UE may include control information and data. In this regard, the transceiver 910 may include an RF transmitter for up-converting and amplifying a frequency of a transmitted signal, and an RF receiver for amplifying low-noise and down-converting a frequency of a received signal. However, this is only an example of the transceiver 910 and components of the transceiver 910 are not limited to the RF transmitter and the RF receiver.

The transceiver 910 may receive and output, to the processor 930, a signal through a wireless channel, and transmit a signal output from the processor 930 through the wireless channel.

The memory 920 may store a program and data required for operations of the network entity. Also, the memory 920 may store control information or data included in a signal obtained by the network entity. The memory 920 may be a storage medium, such as a ROM, a RAM, a hard disk, a CD-ROM, and a DVD, or a combination of storage media.

The processor 930 may control a series of processes such that the network entity operates as described above. For example, the transceiver 910 may receive a data signal including a control signal, and the processor 930 may determine a result of receiving the data signal.

The various actions, acts, blocks, steps, or the like in the flow charts (S500 and S600) may be performed in the order presented, in a different order or simultaneously. Further, in some embodiments, some of the actions, acts, blocks, steps, or the like may be omitted, added, modified, skipped, or the like without departing from the scope of the disclosure.

There is provided a method for managing aerial subscription information of an Uncrewed Aerial Vehicle (UAV) in a wireless network, and the method comprise receiving, by an Access and Mobility Management Function (AMF) device in the wireless network, a first registration request message including a Civil Aviation Administration (CAA)-level UAV identifier from the UAV for accessing an Uncrewed Aerial System (UAS) service, determining, by the AMF device whether an aerial subscription for the UAS service is enabled for the UAV 100 in the wireless network, sending, by the AMF device 200, a registration reject message with an indication indicating the UAS service is not available to the UAV 100 in response to determining that the aerial subscription for the UAS service is not enabled for the UAV 100, receiving, by the AMF device 200, the second registration message the normal service form the UAV 100 and registering, by the AMF device 200, the UAV for the normal service after receiving the second registration message.

The AMF device 200 receives subscription information from an unified data management (UDM) device 300 and checks whether the aerial subscription for the UAS service is enabled for the UAV 100.

The method comprises determining, by the UDM device, that the aerial subscription for the UAS service has been enabled for the UAV by a network operator over a period of time indicating, by the UDM device, to the AMF device that the aerial subscription for the UAS service has been enabled for the UAV and sending, by the AMF device, the aerial subscription information to the UAV with an indication indicating the UAS service is available to the UAV, wherein the AMF device sends the aerial subscription information to the UAV in one of a UE configuration update (UCU) procedure or a UE parameter update (UPU) procedure.

Upon determining by the AMF device that the aerial subscription is enabled for the UAV after receiving the first registration request message, the method comprises registering, by the AMF device, the UAV for the UAS service based on the aerial subscription information available at the AMF device, and sending, by the AMF device, a registration accept message to the UAV for the UAS service.

The method comprises registering, by the AMF device, a third registration message with the CAA-level UAV identifier from the UAV for the UAS service and registering, by the AMF device, the UAV for the normal service after receiving the third registration message.

Receiving, by the AMF device, the third registration request message with the CAA-level UAV identifier from the UAV for the UAS service comprises receiving, by the AMF device, a mobility registration update message or a periodic registration update message with the CAA-level UAV identifier from the UAV for the UAS service to obtain the UAS service without interrupting an existing registration for the normal service.

The method comprises receiving, by the AMF device, a de-registration request message from the UAV to deregister from the normal services, sending, by the AMF device, a de-registration accept message to the UAV and receiving, by the AMF device, the third registration request message with the CAA-level UAV identifier from the UAV for the UAS service.

There is provided a method for managing aerial subscription information to an uncrewed Aerial Vehicle (UAV) in a wireless network, and the method comprise sending, by the UAV, a first registration request message with a CAA-level UAV identifier to an Access and Mobility Management Function (AMF) device in the wireless network for an Uncrewed Aerial System (UAS) service, receiving, by the UAV, a registration reject message with an indication indicating the UAS service is not available from the AMF device when an aerial subscription for the UAS service is not enabled for the UAV by a unified Data Management (UDM) device in the wireless network, sending by the UAV, a second registration request message for a normal service in response to determining that the aerial subscription for the UAS service is not enabled for the UAV, receiving, by the UAV, a registration accept message for the normal service from the AMF device, receiving, by the UAV, the aerial subscription information from the AMF device when the aerial subscription for the UAS service is enabled for the UAV by the UDM device over a period of time, sending, by the UAV, a third registration request message with the CAA-level UAV identifier to the AMF device for the UAS service based on the received aerial subscription information and receiving, by the UAV, a registration accept message for the UAS service from the AMF device.

The UAV receives the aerial subscription information from the AMF device in one of a UE configuration update (UCU) procedure or a UE parameter update (UPU) procedure.

Sending, by the UAV, the third registration request message with the CAA-level UAV identifier to the AMF device for the UAS service based on the aerial subscription information comprises sending, by the UAV, a mobility registration update message or a periodic registration update message with the CAA-level UAV identifier to the AMF device to obtain the UAS service.

Sending, by the UAV, the third registration request message with the CAA-level UAV identifier to the AMF device for the UAS service based on the aerial subscription information comprises detecting, by the UAV, an ongoing active PDU session associated with the normal service, determining, by the UAV, whether the ongoing active PDU session is completed, sending, by the UAV, a de-registration request message for de registering from the normal service to the AMF device, receiving, by the UAV, a de-registration accept message from the AMF device and sending, by the UAV, the third registration request message with the CAA-level UAV identifier to the AMF device for the UAS service.

There is provided a wireless network for managing aerial subscription information of an uncrewed Aerial Vehicle (UAV) in the wireless network, wherein the wireless network comprises a unified Data Management (UDM) device and an Access and Mobility Management Function (AMF) device communicating with the UDM device, wherein the AMF device comprises a memory, a processor and an aerial subscription information controller, communicatively coupled to the memory and the processor, configured to receive a first registration request message comprising a Civil Aviation Administration (CAA)-level UAV identifier from the UAV for accessing an Uncrewed Aerial System (UAS) service, determining whether an aerial subscription for the UAS service is enabled for the UAV in the wireless network, send a registration reject message with an indication indicating the UAS service is not available to the UAV in response to determining that the aerial subscription for the UAS service is not enabled for the UAV, receive the second registration message the normal service form the UAV and register the UAV for a normal service after receiving the second registration message.

The AMF device receives subscription information from an unified data management device (UDM) and checks whether the aerial subscription for the UAS service is enabled for the UAV.

The UDM devices determines that the aerial subscription for the UAS service has been enabled for the UE by a network operator over a period of time, the UDM indicates to the AMF that the aerial subscription for the UAS service has been enabled for the UAV and the AMF device sends the aerial subscription information to the UAV with an indication indicating the UAS service is available to the UAV, wherein the AMF device sends the aerial subscription information to the UAV in one of a UE configuration update (UCU) procedure or a UE parameter update (UPU) procedure.

Upon determining by the AMF that the aerial subscription is enabled for UE after receiving the first registration request message, the aerial subscription information controller is configured to register the UAV for the UAS service based on the aerial subscription information available at the AMF device and send a registration accept message to the UAV for the UAS service.

The AMF device receives a third registration message with the CAA-level UAV identifier from the UAV for the UAS service and registers the UAV for the normal service after receiving the third registration message.

receiving the third registration request message with the CAA-level UAV identifier from the UAV for the UAS service comprises receiving a mobility registration update message or a periodic registration update message with the CAA-level UAV identifier from the UAV for the UAS service to obtain the UAS service without interrupting an existing registration for the normal service.

The aerial subscription information controller further configured to receive a de-registration request message from the UAV to deregister from the normal services send a de-registration accept message to the UAV and receive the second registration request message with the CAA-level UAV identifier from the UAV for the UAS service.

There is provide an Uncrewed Aerial Vehicle (UAV) for managing aerial subscription information in a wireless network, and the UAV comprises a memory, a processor and an aerial subscription information controller, communicatively coupled to the memory and the processor, configured to send a first registration request message comprising a CAA-level UAV identifier to an Access and Mobility Management Function (AMF) device in the wireless network for accessing an Uncrewed Aerial System (UAS) service, receive a registration reject message with an indication indicating the UAS service is not available from the AMF device when an aerial subscription for the UAS service is not enabled for the UAV by a unified Data Management (UDM) device in the wireless network, send a second registration request message for a normal service in response to determining that the aerial subscription for the UAS service is not enabled for the UAV, receive a registration accept message for the normal service from the AMF device, receive the aerial subscription information from the AMF device, when the aerial subscription for the UAS service is enabled for the UAV by the UDM device, send a third registration request message with the CAA-level UAV identifier to the AMF device for the UAS service based on the received aerial subscription information and receive a registration accept message for the UAS service from the AMF device.

The UAV receives the aerial subscription information from the AMF device in one of a UE configuration update (UCU) procedure or a UE parameter update (UPU) procedure.

sending the third registration request message with the CAA-level UAV identifier to the AMF device for the UAS service based on the aerial subscription information comprises sending a mobility registration update message or a periodic registration update message with the CAA-level UAV identifier to the AMF device to obtain the UAS service.

The sending the third registration request message with the CAA-level UAV identifier to the AMF device for the UAS service based on the aerial subscription information comprises detecting an ongoing active PDU session associated with the normal service, determining whether the ongoing active PDU session is completed, sending a de-registration request message for de-registering from the normal service to the AMF device, receiving a de-registration accept message from the AMF device and sending the third registration request message with the CAA-level UAV identifier to the AMF device for the UAS service.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method for managing aerial subscription information of an uncrewed aerial vehicle (UAV) in a wireless network, the method comprising:
receiving, by an access and mobility management function (AMF) device in the wireless network, a first registration request message including a civil aviation administration (CAA)-level UAV identifier from the UAV for accessing an uncrewed aerial system (UAS) service;
determining, by the AMF device, whether an aerial subscription for the UAS service is allowed for the UAV in the wireless network;
sending, by the AMF device, a registration reject message with an indication that the UAS service is not available to the UAV in response to determining that the aerial subscription for the UAS service is not allowed for the UAV;
receiving, by the AMF device, a second registration request message for a standard service from the UAV; and
registering, by the AMF device, the UAV for the standard service after receiving the second registration request message.

2. The method of claim 1, wherein the AMF device receives subscription information from a unified data management (UDM) device and checks whether the aerial subscription for the UAS service is allowed for the UAV.

3. The method of claim 2, further comprising:
determining, by the UDM device, that the aerial subscription for the UAS service has been allowed for the UAV by a network operator for a predetermined period of time;
indicating, by the UDM device, to the AMF device that the aerial subscription for the UAS service has been allowed for the UAV; and
sending, by the AMF device, the aerial subscription information to the UAV with an indication that the UAS service is available to the UAV, wherein the AMF device sends the aerial subscription information to the UAV in one of a user equipment (UE) configuration update (UCU) procedure or a UE parameter update (UPU) procedure.

4. The method of claim 3, further comprising:
registering, by the AMF device, a third registration request message with the CAA-level UAV identifier from the UAV for the UAS service; and
registering, by the AMF device, the UAV for the standard service after receiving the third registration request message.

5. The method of claim 4, wherein receiving, by the AMF device, the third registration request message with the CAA-level UAV identifier from the UAV for the UAS service comprises:
receiving, by the AMF device, a mobility registration update message or a periodic registration update message with the CAA-level UAV identifier from the UAV for the UAS service to obtain the UAS service without interrupting an existing registration for the standard service.

6. The method of claim 4, further comprising:
receiving, by the AMF device, a de-registration request message from the UAV to deregister from the standard service; sending, by the AMF device, a de-registration accept message to the UAV; and
receiving, by the AMF device, the third registration request message with the CAA-level UAV identifier from the UAV for the UAS service.

7. The method of claim 1, wherein, upon determining by the AMF device that the aerial subscription is allowed for the UAV after receiving the first registration request message, the method comprises:
registering, by the AMF device, the UAV for the UAS service based on the aerial subscription information available at the AMF device; and
sending, by the AMF device, a registration accept message to the UAV for the UAS service.

8. A method for managing aerial subscription information to an uncrewed aerial vehicle (UAV) in a wireless network, the method comprising:
sending, by the UAV, a first registration request message with a civil aviation administration (CAA)-level UAV identifier to an access and mobility management function (AMF) device in the wireless network for an uncrewed aerial system (UAS) service;
receiving, by the UAV, a registration reject message with an indication that the UAS service is not available from the AMF device when an aerial subscription for the UAS service is not allowed for the UAV by a unified data management device in the wireless network;
sending by the UAV, a second registration request message for a standard service in response to determining that the aerial subscription for the UAS service is not allowed for the UAV;
receiving, by the UAV, a registration accept message for the standard service from the AMF device;
receiving, by the UAV, the aerial subscription information from the AMF device when the aerial subscription for the UAS service is allowed for the UAV by the UDM device for a predetermined period of time;
sending, by the UAV, a third registration request message with the CAA-level UAV identifier to the AMF device for the UAS service based on the received aerial subscription information; and
receiving, by the UAV, a registration accept message for the UAS service from the AMF device.

9. The method of claim 8, wherein the UAV receives the aerial subscription information from the AMF device in one of a user equipment (UE) configuration update (UCU) procedure or a UE parameter update (UPU) procedure.

10. The method of claim 8, wherein sending, by the UAV, the third registration request message with the CAA-level UAV identifier to the AMF device for the UAS service based on the aerial subscription information comprises:
sending, by the UAV, a mobility registration update message or a periodic registration update message with the CAA-level UAV identifier to the AMF device to obtain the UAS service.

11. The method of claim 8, wherein sending, by the UAV, the third registration request message with the CAA-level UAV identifier to the AMF device for the UAS service based on the aerial subscription information comprises:
detecting, by the UAV, an ongoing active protocol data unit (PDU) session associated with the standard service;
determining, by the UAV, whether the ongoing active PDU session is completed;
sending, by the UAV, a de-registration request message for de-registering from the standard service to the AMF device;
receiving, by the UAV, a de-registration accept message from the AMF device; and
sending, by the UAV, the third registration request message with the CAA-level UAV identifier to the AMF device for the UAS service.

12. A wireless network for managing aerial subscription information of an uncrewed aerial vehicle (UAV) in the wireless network, the wireless network comprising:
a unified data management (UDM) device; and
an access and mobility management function (AMF) device communicating with the UDM device, wherein the AMF device comprises:
a memory;
a processor; and
an aerial subscription information controller, communicatively coupled to the memory,
wherein the processor is configured to:
receive a first registration request message comprising a civil aviation administration (CAA)-level UAV identifier from the UAV for accessing an uncrewed aerial system (UAS) service;
determine whether an aerial subscription for the UAS service is allowed for the UAV in the wireless network;
send a registration reject message with an indication that the UAS service is not available to the UAV in response to determining that the aerial subscription for the UAS service is not allowed for the UAV;
receive a second registration request message for a standard service from the UAV; and
register the UAV for the standard service after receiving the second registration request message.

13. The wireless network of claim 12, wherein the AMF device is configured to receive subscription information from the UDM and check whether the aerial subscription for the UAS service is allowed for the UAV.

14. The wireless network of claim 13,
wherein the UDM device is configured to determine that the aerial subscription for the UAS service has been allowed for the UE by a network operator for a predetermined period of time,
wherein the UDM is configured to indicate to the AMF that the aerial subscription for the UAS service has been allowed for the UAV,
wherein the AMF device is configured to send the aerial subscription information to the UAV with an indication that the UAS service is available to the UAV, and
wherein the AMF device is configured to send the aerial subscription information to the UAV in one of a user equipment (UE) configuration update (UCU) procedure or a UE parameter update (UPU) procedure.

15. The wireless network of claim 14, wherein the AMF device is configured to:
receive a third registration request message with the CAA-level UAV identifier from the UAV for the UAS service; and
register the UAV for the standard service after receiving the third registration request message.

16. The wireless network of claim 15,
wherein the AMF device is configured to receive a mobility registration update message or a periodic registration update message with the CAA-level UAV identifier from the UAV for the UAS service to obtain the UAS service without interrupting an existing registration for the standard service.

17. The wireless network of claim 15, wherein the AMF device is configured to:
receive a de-registration request message from the UAV to deregister from the standard service;
send a de-registration accept message to the UAV; and
receive the second registration request message with the CAA-level UAV identifier from the UAV for the UAS service.

18. The wireless network of claim 12, wherein, upon determining by the AMF that the aerial subscription is allowed for UE after receiving the first registration request message, the aerial subscription information controller is further configured to:
register the UAV for the UAS service based on the aerial subscription information available at the AMF device; and
send a registration accept message to the UAV for the UAS service.

19. An uncrewed aerial vehicle (UAV) for managing aerial subscription information in a wireless network, the UAV comprising:
a memory;
a processor; and
an aerial subscription information controller communicatively coupled to the memory, wherein the processor is configured to:
send a first registration request message comprising a civil aviation administration (CAA)-level UAV identifier to an access and mobility management function (AMF) device in the wireless network for accessing an uncrewed aerial system (UAS) service;
receive a registration reject message with an indication that the UAS service is not available from the AMF device when an aerial subscription for the UAS service is not allowed for the UAV by a unified data management (UDM) device in the wireless network;
send a second registration request message for a standard service in response to determining that the aerial subscription for the UAS service is not allowed for the UAV;
receive a registration accept message for the standard service from the AMF device;
receive the aerial subscription information from the AMF device, when the aerial subscription for the UAS service is allowed for the UAV by the UDM device;
send a third registration request message with the CAA-level UAV identifier to the AMF device for the UAS service based on the received aerial subscription information; and
receive a registration accept message for the UAS service from the AMF device.

20. The UAV of claim 19, wherein the UAV is configured to receive the aerial subscription information from the AMF device in one of a user equipment (UE) configuration update (UCU) procedure or a UE parameter update (UPU) procedure.
